(19) United States
(12) Patent Application Publication
(10) Pub. No.: US 2008/0244373 A1
(43) Pub. Date: Oct. 2, 2008

(54) Methods, systems, and computer program products for automatically creating a media presentation entity using media objects from a plurality of devices

(76) Inventors: Robert P. Morris, Raleigh, NC (US); Mona Singh, Cary, NC (US)

Correspondence Address: SCENERA RESEARCH, LLC;JENKINS, WILSON, TAYLOR & HUNT, P.A., 3100 TOWER BLVD, SUITE 1200, DURHAM, NC, 27707, US

(21) Appl. No.: 11/728,360

(22) Filed: Mar. 26, 2007

(51) Int. Cl. G06F 17/00; G06F 3/00

(52) U.S. Cl. 715/202; 707/103 R; 715/730

(57) ABSTRACT

The subject matter described herein includes methods, systems, and computer program products for automatically creating an MPE using media objects from a plurality of devices. According to one aspect, the method includes receiving a plurality of media objects from a plurality of devices and identifying media objects associated with a media session from the received media objects. Presentation parameters are received for creating an MPE from the received media objects associated with the media session. Using the presentation parameters, an MPE is automatically created based on the media objects associated with the media session, where the MPE includes a plurality of sets of media objects, and at least one of the sets includes media objects from different devices.

### TECHNICAL FIELD

The subject matter described herein relates to creating a media presentation entity (MPE). More particularly, the subject matter described herein relates to methods, systems, and computer program products for automatically creating an MPE using media objects from a plurality of devices.

### BACKGROUND

The number, variety, and sophistication of devices with media capabilities, including media capture capabilities, has greatly expanded in recent years. Cell phones with built-in digital cameras and microphones, as well as digital video and still cameras are just a few examples. Therefore, it is increasingly common for multiple recordings of events to be captured in a variety of formats from multiple devices by multiple people. Moreover, captured images, audio, video, and multimedia objects are often associated with additional information that is useful for identifying and categorizing captured media, such as location, subject, or time data. In either case, the process of combining captured media from multiple sources into an organized presentation entity is typically a manual process.

Conventionally, users editing captured video, for example, must manually download the video from a video camera into a dedicated video-editing software program. The user may then manually tag scenes of interest within the video, and organize selected scenes into a final product. The same process may be repeated for other types of media, and then combined by the user into a larger multimedia entity, such as a slideshow presentation or sequence of video clips.

One problem with conventional systems and methods for creating multimedia entities using media captured from a variety of devices is that a large amount of manual input is required. Accordingly, a need exists for improved methods and systems for automatically creating an MPE using media objects captured from a plurality of devices.

### SUMMARY

The subject matter described herein includes methods, systems, and computer program products for automatically creating an MPE using media objects from a plurality of devices. According to one aspect, one method includes receiving a plurality of media objects from a plurality of devices. The method also includes identifying media objects associated with a media session from the received media objects. Presentation parameters are received for creating an MPE from the media objects associated with the media session. Using the presentation parameters, the MPE is automatically created based on the media objects associated with the media session, the MPE including a plurality of sets of media objects, where at least one of the sets includes media objects from different devices.

According to another aspect, a system for automatically creating an MPE using media objects from a plurality of devices includes a content handler for receiving a plurality of media objects from a plurality of devices. The system also includes an MPE engine for identifying media objects associated with a media session from the received media objects and for receiving presentation parameters for creating an MPE from the media objects associated with the media session. Further, the system includes an entity builder for automatically creating, using the presentation parameters, the MPE based on the media objects associated with the media session, the MPE including a plurality of sets of media objects, where at least one of the sets includes media objects from different devices.

### BRIEF DESCRIPTION OF THE DRAWINGS

The subject matter described herein will now be explained with reference to the accompanying drawings of which:

FIG. 1 is a flow chart of a process for automatically creating an MPE using media objects from a plurality of devices according to an embodiment of the subject matter described herein;

FIG. 2 is a block diagram of an exemplary system for automatically creating an MPE using media objects from a plurality of devices according to an embodiment of the subject matter described herein;

FIG. 3 is a more detailed block diagram of an exemplary system for automatically creating an MPE using media objects from a plurality of devices according to an embodiment of the subject matter described herein; and

FIG. 4 is an entity-relationship (E-R) diagram of exemplary database tables for storing information used for automatically creating an MPE using media objects from a plurality of devices according to an embodiment of the subject matter described herein.

### DETAILED DESCRIPTION

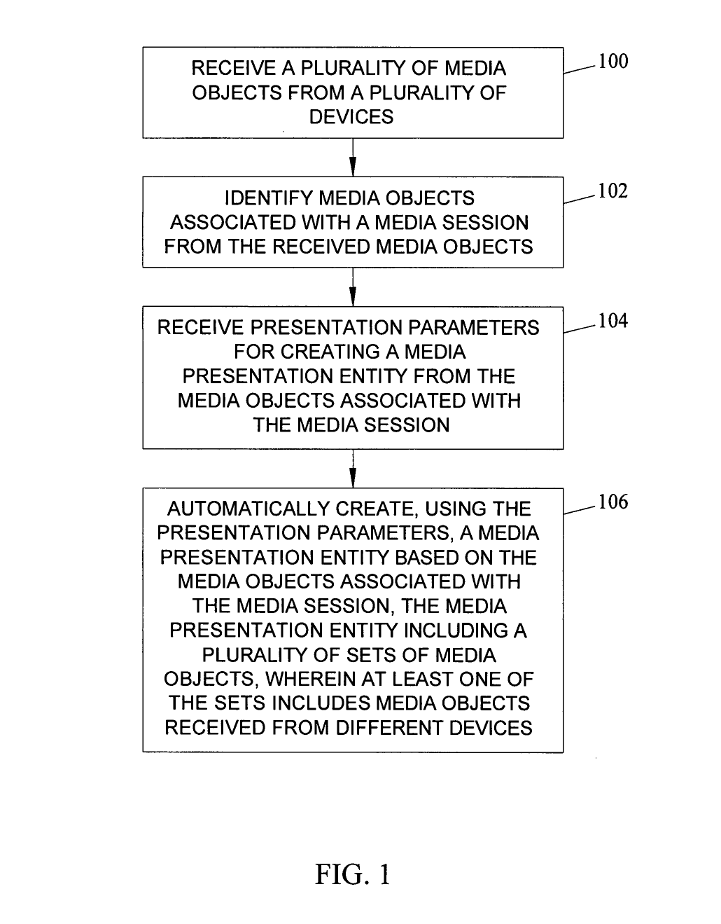

FIG. 1 is a flow chart of a process for automatically creating an MPE using media objects from a plurality of devices according to an embodiment of the subject matter described herein. Referring to FIG. 1, in block 100, a plurality of media objects from a plurality of devices is received.

A media object is digital information including a portion that is presentable as at least one of audio data and image data. Exemplary media objects include an audio media object, a video media object, an image media object, and a multimedia media object. For example, a media object may be an audio clip, a video, an image, or any combination thereof.

A device may be any device suitable for providing one or more media objects. For example, a device may be a media capture device such as a still-image media capture device, a video media capture device, an audio media capture device, a scanner, or any combination thereof. Media objects may also be associated with media session information for identifying a media session. Media session information may be associated with a media object in a variety of ways. For example, media session information may be included within a media object, received in a message separate from the media object and associated with the media object, located in a file separate from the media object and associated with the media object, or received via a user interface. In one embodiment, media session information may include a media session identifier (media session ID) for identifying a media session.

In an embodiment, a media object may be identified using information associated with the object suitable for use in locating the associated media object or by receiving the media object. Information suitable for locating an associated media object is referred to in this document as media information. Media information may include a uniform resource identifier (URI), a filename and a path, or any other suitable media object identifier (media object ID).

Furthermore, a media object may be associated with more than one media session. This may be achieved, for example, by associating more than one media session ID with a single media object ID. A media session ID may be any information suitable for use in locating a plurality of media objects associated with the same media session. For example, a media session ID may include a number or a text string.

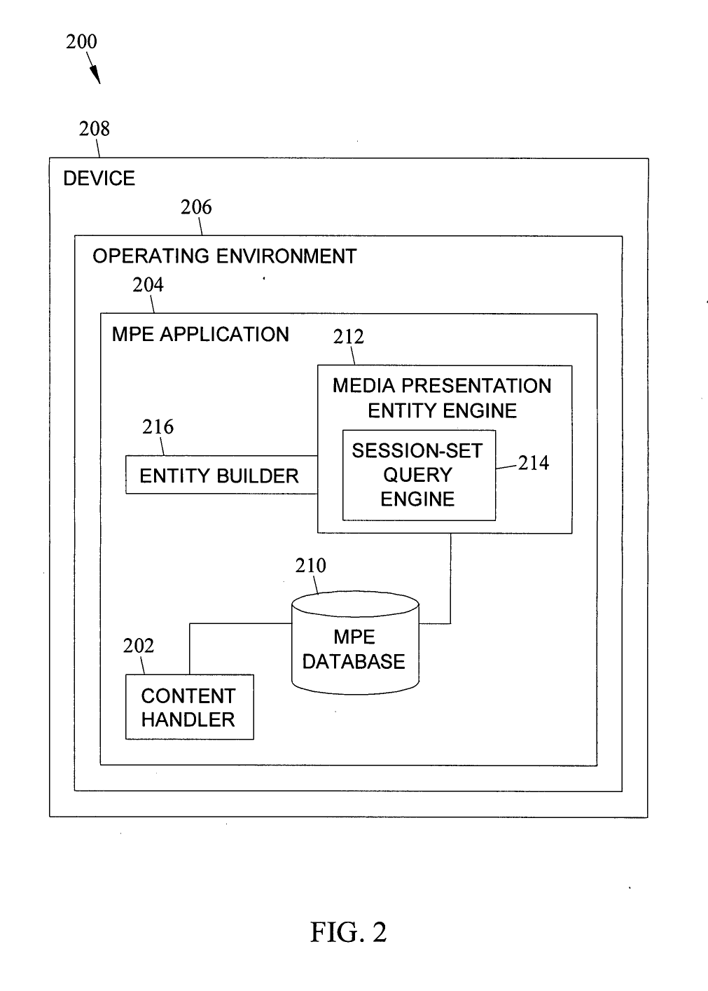

FIG. 2 is a block diagram of an exemplary system for automatically creating an MPE using media objects from a plurality of devices according to an embodiment of the subject matter described herein. Referring to FIG. 2, system 200 includes means for receiving a plurality of media objects from a plurality of devices, as described in block 100.

For example, content handler 202 is configured to receive a plurality of media objects from a plurality of devices, such as one or more media capture devices. In FIG. 2, content handler 202 may be part of MPE application 204 that operates in an execution environment 206 provided by device 208. Exemplary operating environment 206 may include a processor, a processor memory, an operating system or control program, and subsystems for supporting hardware components including an input device such as a keyboard, an output device such as display, and an input subsystem for receiving data such as a drive for reading a removable storage medium and/or a network interface card (NIC) for connection to a communications network.

In one embodiment, content handler 202 receives a plurality of media objects each associated with a source device from one or more of storage areas including media objects. The media object storage areas may be, for example, a removable storage medium and/or a persistent storage medium, such as a digital versatile disc (DVD) or a hard disk drive. A media object storage area described above may be located locally or remotely to device 208. For example, content handler 202 may interoperate with a device 208 subsystem operatively connected to a locally-attached hard-disk drive including one or more media objects. Content handler 202 may also interoperate with a communication subsystem that includes a network stack operatively coupled to a NIC connected to a communications network such as a local area network (LAN) or a wide area network (WAN) to receive media objects.

In another embodiment, media information associated with a media object and suitable for use in locating the associated media object is received. Media information may include, for example, a media object ID, such as a URI or a filename and a path. In one embodiment, content handler 202 receives a URI indicating the location of one or more media objects. Media information may identify a device associated with the media object or the referenced media object may be associated with information identifying a source device. The URI may be embedded in a web page for viewing with a web browser, and upon viewing, the associated media object identified by the embedded URI may be retrieved and presented by the web browser.

Regardless of the mechanism used for receiving media objects, the received media objects from a plurality of source devices are associated with media session information. Media session information can be included in a media object, received in a message optionally including an associated media object, located in a file optionally associated with a media object, or can be received via a user interface of MPE application 204 for receiving media session information and associating it with a media object as will be described in more detail later.

Media objects in a media session can be a single type of media object or can include media objects corresponding to a mix of media types. A media type can be an audio media type, a video media type, an image media type, or a multimedia type. A text content type can be received and used in generating an MPE where the text content may be used to augment the MPE, in some embodiments.

In exemplary system 200, content handler 202 stores received media objects and associated source device information in MPE database 210. Media session information for a media object is stored, for example in a media session record associated with the media object by MPE engine 212. MPE engine 212 stores the media session information in MPE database 210. MPE engine 212 can receive media session information from content handler 202 via direct communication and/or can receive session media information indirectly via MPE database 210. For example, indirect communication can occur when a media object is stored in MPE database 210. A notification including information identifying the stored media object and the associated media session ID may be sent to MPE engine 212. MPE engine 212 then using information in the notification determines a media object ID identifying the media object and the media session ID identifying the media session. MPE engine 212 stores the media session ID and the media object ID in a MPE database 210 media session record created for associating a media object with a media session. Alternately, the media session ID is stored along with the media object in a media object record. Some embodiments restrict a media object to one media session while other embodiments allow a media object to be associated with multiple media sessions.

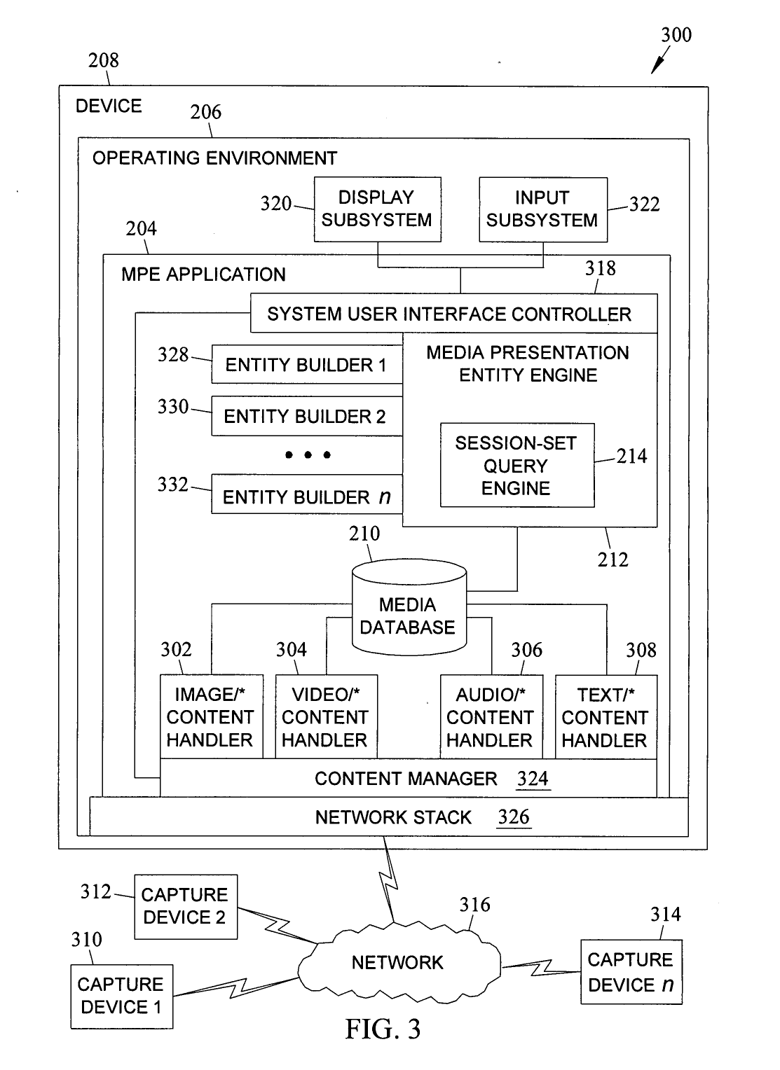

FIG. 3 is a more detailed block diagram of an exemplary system for automatically creating an MPE using media objects from a plurality of devices according to an embodiment of the subject matter described herein. Referring to FIG. 3, system 300 includes means for receiving a plurality of media objects from a plurality of devices, as described in block 100. For example, content handlers 302-308 may receive a plurality of media objects from media capture devices 310-314.

In FIG. 3, MPE application 204 includes several content handlers 302-308 for processing a variety of content types including media types. For example, MPE application 204 includes an image/* content handler 302, a video/* content handler 304, and an audio/* content handler 306 for processing still images, video, and audio media types, respectively, of various formats. A text/* content handler 308 for processing text content types may also be included in MPE application 204. In order to route media objects to the appropriate content handler, content manager 324 determines the content type of each media object and provides the media object to a content handler 302-308 configured to process media objects of the determined content type. Each content handler 302-308 parses a media object received, and creates or updates a media object record in the MPE database 210. For example, if a new video media object is received, the new video media object is provided to video/* content handler 304, which parses the media object and creates a video media object record in MPE database 210.

The media objects and text received by content handlers 302-308 may be received from, and optionally generated by, one or more devices 310-314 in communication with MPE application 204 via network 316. For ease of discussion, devices 310-314 participating in a media session as illustrated in FIG. 3 are media capture devices. For example, capture devices 310-314 may include devices for capturing images, audio, video, and/or multimedia media objects. However, it is appreciated that non-capture devices may also be connected to MPE application 204 for providing information associated with media objects as well as providing media objects captured by another device with media capture capability.

MPE application 204 provides system user interface (SUI) controller 318 for receiving input for creating a media session and receiving presentation parameters specifying an MPE to be generated in association with the media session. The user interface for media session creation and configuration is displayed as directed by SUI controller 318 on a display (not shown) in communication with display subsystem 320 and input is received via input subsystem 322. The display (not shown) and the input devices (not shown) can be local to device 208 as is typical of locally hosted applications. The display and input device(s) can be remote, for example, MPE application 204 in an embodiment is a web application providing a user interface for displaying and receiving input via a browser.

In an example media session, MPE application 204 receives device information associated with devices, such as devices 310-314 that are allowed to participate in the media session. Devices 310-314 are allowed to send media objects to MPE application 204 for inclusion in the media session. In the example, specifications for an MPE requiring a video and a plurality of still images where all media are captured in a specified time period and/or location or locations are received via the SUI controller 318 as presentation parameters and associated with the media session. MPE presentation parameters are stored in media database 210 by MPE engine 212 using input received via SUI controller 318.

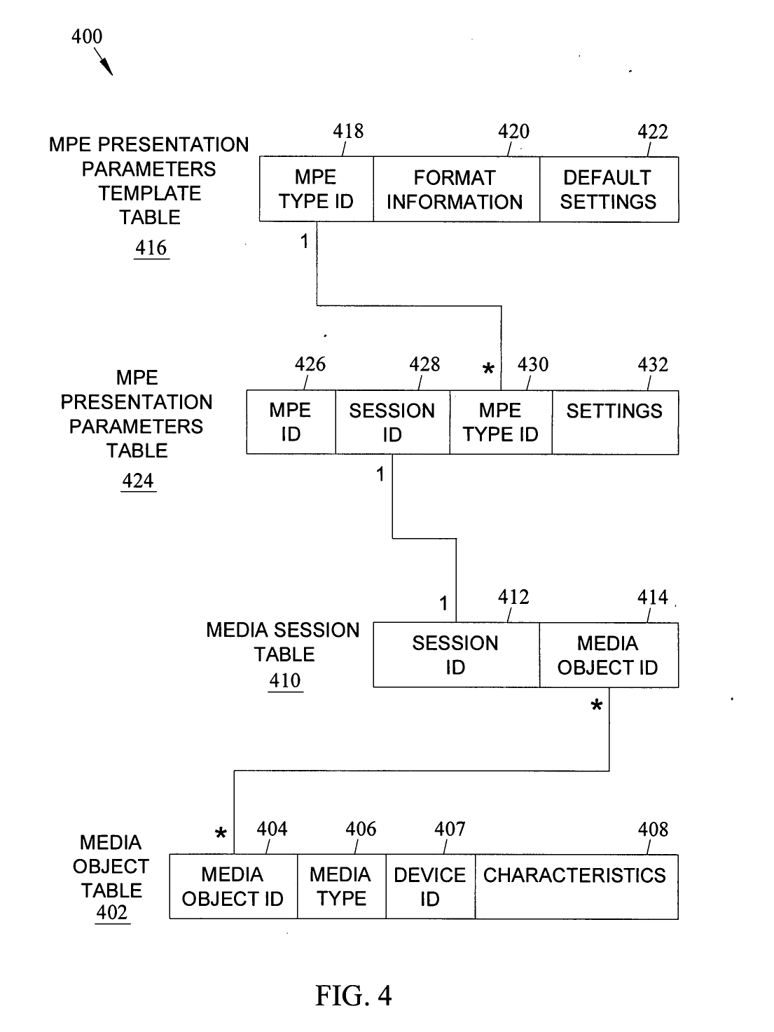

FIG. 4 is an E-R diagram of exemplary tables in database 210 for storing information used for automatically creating an MPE using media objects from a plurality of devices according to an embodiment of the subject matter described herein. Referring to FIG. 4, tables 402, 410, 416, and 424 may be located in MPE database 210. Media object table 402 and media session table 410 may store information associated with the plurality of media objects received in block 100.

Device information may be included in media session creation data and/or in MPE creation data in an embodiment. Device information includes a message address used to address a message by SUI controller 318 to a device 310-314. SUI controller 318 provides the address and message content including media session information to content manager 324 for formatting for transmission. Content manager 324 uses a network stack 326 of the device's 208 operating environment 206 to send an invitation message via the network 316 to each device 310-314 included in the media session, in an example scenario.

Media session information included in the content of an invitation is used by a device 310-314 to associate a captured media object with an identified media session. In response, device 310-314 sends a captured media object in an add message identifying a source device along with media session information via network 316. The session information can be embedded in the media object and/or stored in the add message apart from the media object. The add message is received by network stack 326 via the NIC (not shown) of device 208 operatively coupled to network 316. Network stack 326 provides the add message to content manager 324 of MPE application 204.

MPE application 204 in system 300 includes content handlers 302-308 as described earlier for handling a variety of content types. As previously described, content manager 324 determines the content type of each media object in a message and provides the media object to a content handler 302-308 configured for processing media objects of the determined content type. If text data is received, the text is provided to the text/* content handler 308 along with information associating the text with the media object received with the text data.

Each content handler 302-308 in system 300 and content handler 202 in system 200 parses a media object received, and creates or updates a corresponding media object record in MPE database 210, such as a row of media object table 402 depicted in E-R diagram 400. Media object table 402 includes media object ID column 404 for identifying a media object, media type column 406 for storing a multipurpose Internet mail extensions (MIME) type of the media object, a device ID column 407 for identifying a source device, and one or more characteristics columns 408 for storing characteristics associated with the media object. In an example using media object table 402, a media object ID stored in media object ID column 404 of a record in the table is formatted as a URI and is usable for locating the media object. The media object, in an embodiment, is stored as one or more files on a file system of operating environment 206. A device ID may uniquely identify a device or may identify a device as a unique source of media objects with a media session. For example, in a media session restricted to one still image capture device and one video capture device, the type of media is suitable for identifying the different sources of media objects in the session.

A media object record of media object table 402 can include media session information for associating the media object to a session. Alternately, content handler 202, 302-308 can pass media object information and media session information to MPE engine 212 for creating or updating a media session record in MPE database 210. Media session table 410 in E-R diagram 400 illustrates one model for associating a media object with a media session. Media session table 410 allows the storing of a media session record as a row in media session table 410 where the row includes session ID column 412 for identifying a media session and media object ID column 414 for identifying a media object included in the session. In E-R diagram 400 a media object can be included in more than one media session and vice versa as indicated by the many-to-many cardinality indicators of the relationship drawn between media object table 402 and media session table 410 in diagram 400. In an alternate embodiment, media session table 410 includes a source device ID column (not shown) instead of, or in addition to, media object ID column 414. Media objects in a media session can be identified by matching the value in the source device column of media session table 410 row with values in source device ID column 407 in the rows of media object table 402.

If text data is received by text/* content handler 308 where the text data is associated with a particular media object, text/* content handler 308 stores the text data after parsing and formatting for storage in MPE database 210. The storing of the text data associates the text data with the particular media object using media object information received from content manager 324 included in the received message. The text in some embodiments is stored in a characteristic column 408, in other embodiments it is stored in a media object annotation table (not shown), and, in another example embodiment, text is stored in media object table 402 with a column or link table allowing relationships among rows in media object table 402 to be supported.

If text/* content handler 308 receives text data associated with the media session and not associated with any particular media or group of media it is also formatted for storage and stored in either MPE database 210 by text/* content handler 308 or passed to MPE engine 212 for storing in a row of media session table 410 in MPE database 210 or in a media session annotation table (not shown) analogous to the media object annotation table. Regardless of the data storage model, the text is associated with the media session using information in or determined from the media session information included in a message with the text data detected when processed by content manager 324 and provided to text/* content handler 308. Text data can be associated with a source device in some embodiments.

Returning to FIG. 1, in block 102, media objects are identified from the received media objects as being associated with a media session. In FIG. 2, system 200 includes means for identifying media objects from the received media objects as being associated with a media session. For example, in system 200, MPE engine 212 is configured to identify media objects from the received media objects as being associated with a media session.

In an embodiment of the system 200, session-set query engine 214 queries MPE database 210 using media session information to identify media session records that are associated with a specified media session. In the embodiment, each media session record associated with the media session identifies an associated media object in MPE database 210. As stated, in an alternate embodiment, each media session record associated with the media session identifies an associated source device, thus identifying associated media objects in MPE database 210. Using the identifying association between a media session record and a media object, session-set query engine 214 identifies media objects stored in MPE database 210 by content handler 202 that are associated with the media session.

An embodiment of system 300 using a database modeled according to E-R diagram 400, session-set query engine 214 queries media session table 410 in MPE database 210 using media session information to identify media session records that are associated with the media session. Session-set query engine 214 can use a session ID included in or derived from media session information to query media session table 410 to identify all media object IDs in media object ID column 414 that occur in rows including the session ID in session ID column 412. Based on the media object IDs, session-set query engine 214 selects rows from media object table 402 that include each of the media object IDs retrieved from media session table 410. The value of media object ID column 404 of the retrieved rows provides a URI for locating and retrieving the file or files containing a media object in the media session with the given session ID, in an embodiment.

In the example media session discussed previously, invitation messages were sent to a plurality of devices based on device information was received by MPE application 204 where the device information identified devices 310-314. MPE application 204 received add messages, each identifying an associated source device as previously described, resulting in the storing of media object information included in the add messages and source device information in MPE database 210. Media session information was also received via SUI controller 318 as previously described. The session information was provided to devices 310-314 in the invitation messages and returned in the add messages to MPE application 204 allowing the received media objects and source devices to be associated with the identified media session using rows in media session table 410, also described previously.

Session-set query engine 214 using the media session ID provided to devices 310-314 retrieves media object table 402 rows through the rows of media session table 410 associating the media session ID with the received media object IDs. The media objects received from devices 310-314 can be augmented by media objects associated with source devices uploaded to MPE application 204 via a remote interface, such as a browser interface, under the control of SUI controller 318. Further, a user may use a local or a remote interface controlled by SUI controller 318 to remove media objects received from devices 310-314 from the media session resulting in the deletion of corresponding rows in media session table 410. A user may add a media object with an associated record in media object table 402 to the session via a local or remote interface resulting in a row being added to media session table 410 including the media session ID in the session ID column 412 and the media object ID in the media object ID column 414.

In the example discussed above, media session information and device information identifying devices 310-314 were received. Invitation messages were sent to a plurality of devices by content manager 324. MPE application 204 then received add messages each identifying a source device and stored the media objects included in the add messages and source device information in MPE database 210. Continuing the example discussed above, media session information was provided to devices 310-314 in one or more invitation messages and returned to MPE application 204 in one or more add message responses, thereby allowing the received media objects and source devices to be associated with the identified media session. For example, the association can be made by the creation of records in the media session table 410 as previously described.

Whether MPE engine 212 receives media session information as previously described or automatically generates media session information, media session information is associated with one or more media objects associated with the media session. For example, in one embodiment, MPE engine 212 uses session-set query engine 214 to create associations in MPE database 210 between the media session identified by the media session information and the plurality of media objects. In an embodiment using a database conforming to E-R diagram 400, MPE engine 212 provides the media session identifier from the media session information to session-set query engine 214 along with media object identifiers identifying the plurality of media objects to be associated with the media session. Session-set query engine 214 creates a record in media session table 410, where each record created includes the media session ID in the session ID 412 column and one of the plurality of media object IDs in the media object ID column 414.

In FIG. 4, database 400 includes means for identifying media objects from the received media objects as being associated with a media session, as described in block 102. For example, media session table 410 may include one or more rows, where each row includes multiple columns and constitutes a media session record. For example, media session table 410 may include rows including media session ID column 412 and media object ID column 414 for associating a media object with a media session. Media object table 402 may include rows including media object ID column 404 for storing the location of a media object, media type column 406 for storing the media type of a media object, and one or more characteristics column 408 for storing metadata corresponding to the media object.

Media session table 410 shown in FIG. 4 illustrates one model for associating a media object with a media session. Media session table 410 allows the storing of a media session record as a row in the table where the row includes session ID column 412 for identifying a media session and media object ID column 414 for identifying a media object included in the media session. In E-R diagram 400, a media object can be included in more than one media session and vice versa as indicated by the many-to-many cardinality indicators of the relationship drawn between media object table 402 and media session table 410 in diagram 400.

In some embodiments, media session table 414 may also include a device information column (not shown) for storing device information received from devices 310-314 for identifying the devices permitted to participate in a given media session. In other embodiments, device information may be stored in a separate table using a link table to associate a device with a media session.

It is appreciated that media objects received from devices, such as devices 310-314, may be added to or removed from the media session via a local or a remote interface controlled by SUI controller 318. The addition or removal of a media object would result in the addition or deletion of corresponding information in rows of media session table 410 and/or media object table 402. For example, a user may add a media object with an associated record in media object table 402 to the media session via a local or remote interface resulting in a row being added to media session table 410 that includes a media session ID in media session ID column 412 and a media object ID in media object ID column 414. Analogously, media objects can be removed by removing a source device.

Returning to FIG. 1, in block 104, presentation parameters are received for creating an MPE from the media objects associated with the media session. FIGS. 2, 3 and 4 include means for performing the step described in block 104.

In FIG. 2, system 200 includes means for receiving presentation parameters for creating an MPE from the media objects associated with the media session. For example, system 200 includes an MPE engine 212 configured to receive presentation parameters for creating an MPE from the media objects associated with media session information indicating that the media objects are associated with the corresponding media session.

In one embodiment of system 200, MPE engine 212 may receive presentation parameters from a user interface of MPE application 204. In another embodiment, MPE engine 212 may receive presentation parameters from a locally attached device using a file subsystem (not shown) of operating environment 206. In other embodiments, MPE engine 212 may receive presentation parameters from a remotely located client application via a communication subsystem of operating environment 206.

In the embodiment described above wherein MPE engine 212 receives presentation parameters from a local data store, such as a removable storage media in a compatible drive of device 208, MPE engine 212 may receive a notification of the presence of the removable media. In response to receiving the notification, MPE engine 212 may determine whether a recognized file name is present on the detected media. If MPE engine 212 determines such a file exists, it may read the file and retrieve any included presentation parameters. In some embodiments, retrieved files include media presentation parameters associated with a media session. Other embodiments allow a user to associate a set of presentation parameters by providing input data through a GUI, for example. It is appreciated that presentation parameters as described above may be associated with other media sessions as well.

In FIG. 3, system 300 includes means for receiving presentation parameters for creating an MPE from the media objects associated with the media session, as described in block 104. For example, system 300 includes SUI controller 318 for receiving presentation parameters specifying an MPE to be generated in association with a media session. SUI controller 318 may be connected to MPE engine 212, display subsystem 320, and input subsystem 322 for receiving presentation parameters from a user interface of MPE application 204 or a storage device, whether locally or remotely connected. A user interface for media session creation and configuration as directed by SUI controller 318 may be displayed on a display (not shown) in communication with display subsystem 320 and input may be received via input subsystem 322. The display (not shown) and input devices (not shown) may be located either locally or remotely to device 208. For example, in an embodiment where MPE application 204 is a desktop application, the display and input device(s) are locally attached to device 208. Alternately, the display and input device(s) may be remotely located from device 208 in an embodiment where, for example, MPE application 204 is a web application providing a user interface for displaying and receiving input via a web browser.

In an example media session for creating an MPE that requires video and still images captured at a specified time and place, MPE application 204 may receive optional device information associated with devices 310-314, as previously described. Devices 310-314 send media objects to MPE application 204 for inclusion in the media session, also previously described. In the example, an MPE requiring a video and a plurality of still images where all media are captured in a specified type period and/or location or locations is specified via the user interface as presentation parameters associated with the media session and suitable for use in creating the MPE. MPE presentation parameters may then be stored in media database 210 by MPE engine 212 using input received via SUI controller 318.

In the context of the system 300, in the example media session discussed previously, invitation messages were sent to the devices 310-314, and add messages including media objects and identifying source devices were received from at least some of the invited devices 310-314. Presentation parameters are can be received via a user interface presented as directed by SUI controller 318. SUI controller 318, via the display subsystem 320 of the operating environment 206, presents an interface for presenting MPE presentation parameters template types and for receiving an indicator for identifying a template as indicated by an MPE presentation parameters template ID. SUI controller 318 then retrieves presentation parameters template information from media database 210 by providing the MPE presentation parameters template ID to MPE engine 212. MPE engine 212 uses the MPE presentation parameters template ID to retrieve MPE presentation parameters template information from media database 210. MPE engine 212 returns the retrieved MPE presentation parameters template information to SUI controller 318. Based on the presentation parameters template information, SUI controller 318 determines which settings and format information are user-configurable, and presents a user interface using display subsystem 320 and input subsystem 322 for presenting the user with user-configurable data and receiving input from the user.

In one embodiment, the media objects to be included in a media session may be selected using device information identifying the devices allowed to provide media objects. This example of MPE creation using MPE application 204 employs what is referred to as a coordinated media session in this document, as it requires the coordination of devices identified in the device information in gathering media objects. In another embodiment, a user may create a media session from media objects already known to MPE application 204. For example, MPE application 204 may allow a user to select media objects stored in MPE database 210 by selecting media objects and/or source devices. It is appreciated that MPE application 204 can support both coordinated media sessions, media sessions where media objects are selected from previously received media objects, and combinations of coordinated and user-selected media sessions. Examples discussed above involving devices 310-314 use a coordinated embodiment of MPE application 204, but are not limited to such an embodiment.

The MPE presentation parameters template and the received settings data are provided to MPE engine 212. In some embodiments, MPE engine 212 may automatically generate an MPE identifier (MPE ID) for the specified MPE. In other embodiments, the user may specify an MPE ID. In either case, MPE engine 212 stores the received MPE presentation parameters in MPE database 210 along with the MPE ID.

In FIG. 4, database 400 includes means for receiving presentation parameters used for creating an MPE from the media objects associated with the media session, as described in block 106. For example, database 400 may store presentation parameters template information in MPE presentation parameters template table 416 and MPE presentation parameters for an MPE associated with an MPE presentation parameters template in MPE presentation parameters table 424.

Referring to FIG. 4, MPE presentation parameters template table 416 includes an MPE type ID column 418 for identifying the MPE presentation parameters template for use in generating an MPE, a format information column 420 for storing MPE format information, and a default settings column 422 for storing zero or more required and/or default presentation settings. Format information located in column 420 identifies a format or schema for a particular MPE as well as the type of media objects required and/or allowed and may indicate numbers and/or proportions of each media type required.

MPE presentation parameters table 424 includes MPE ID column 426 for storing an MPE ID, session ID column 428 for storing a media session ID identifying media capture objects from a plurality of devices used in generating the MPE, MPE type ID column 430 for indicating the MPE presentation parameters template for use in generating the MPE, and zero or more settings columns 432 for storing user provided parameter settings. The MPE ID may be associated with an entity builder 328-332 in system 300 configured to process MPE presentation parameters including format information, media objects, source device information, and settings to produce an MPE of the indicated type. Settings included in the settings column 422 are MPE type specific. Example settings include default values for a size of the presentation, the ordering or sorting of media objects, default colors for borders and backgrounds, and border width.

For exemplary MPE types that use a markup language, such as hypertext markup language (HTML), settings located in column 432 may be specified as one or more cascading style sheets (CSSs).

Some entity builders 328-332 allow the user to configure the output type of a generated MPE. For example, for a streaming video MPE the user may indicate that video is to be embedded in a generated web page for presentation by a web browser. For a non-streaming MPE a user may indicate that the output generated should be PDF, HTML, and/or a slideshow format.

MPE engine 212 returns the retrieved MPE presentation parameters template information to the SUI controller 318. SUI controller 318 determines which settings and format information are user configurable. Based on the determination, SUI controller 318 presents an interface using the display subsystem 320 for presenting the user settable data receives settings from the user via input subsystem 322.

The MPE presentation parameters template and the received settings data are provided to MPE engine 212. MPE engine 212, in one embodiment, automatically generates an identifier for the specified MPE. In an alternate embodiment, the user is allowed to specify an MPE ID. MPE engine 212 stores the MPE presentation parameters in the MPE database 210 along wit the MPE ID. For example, MPE engine 212 creates a row in a media presentation entity table 424. MPE presentation parameters table 424 includes a MPE ID column 426 in the new row for storing MPE ID, a session ID column 428 for storing a media session ID identifying media capture objects used in generating the MPE, an MPE type ID column 430 for indicating the MPE presentation parameters template for use in generating the MPE, and zero or more settings columns 432 for storing user provided parameter settings.

In a coordinating MPE application 204, device information identifying devices allowed to participate in providing media objects, MPE engine 212 automatically generates media session information including a media session ID that is stored in session ID column 428 of the associated MPE. A coordinating MPE 204 stores device information in a column (not shown) of media session table 414, for example. Alternate embodiments can store the device information in a separate table using a link table to associate a device with a session. A non-coordinating MPE application 204 can allow a user to select media objects with rows in MPE database 210. That is, a user can create a media session from media objects already known to MPE application 204. MPE application 204 can support both coordinated, user specified, and combination coordinated-user specified media sessions. The example using the devices 310-314 previously discussed uses a coordinating MPE application 204. The receiving of media objects previously discussed describes at least one reception means for each type of MPE application 204.

Returning to FIG. 1, in block 106, an MPE is automatically created using the presentation parameters and media objects from a plurality of source devices associated with a media session, where the MPE includes a plurality of sets of media objects, where at least one of the sets of media objects includes media objects received from different devices determined using device information associated with each media object. FIGS. 2, 3 and 4, as described below, illustrate means for performing the process described in block 106.

In FIG. 2, system 200 includes means for automatically creating an MPE using presentation parameters and media objects associated with a media session, where the MPE includes a plurality of sets of media objects. At least one of the sets of media objects includes media objects received from different devices, according to block 106. For example, entity builder 216 may receive presentation parameters including media session information from MPE engine 212. Entity builder 216 uses the media session information to request the media objects and source device information associated with the media session to build the MPE. The media objects requested by entity builder 212 may be identified by the media session ID included in media session information in the received presentation parameters. Furthermore, entity builder 212 may receive media object information from session-set query engine 214 retrieved from MPE database 210.

In an embodiment of system 200, MPE engine 212 provides the presentation parameters and the media objects with source device information associated with the media session as identified by session-set query engine 214 to entity builder 216. Entity builder 216 is capable of creating an MPE based on the media objects and source device information associated with the media session and presentation parameters provided, where the MPE includes a plurality of sets of media objects. At least one set includes media objects from different devices determined using device information associated with each media object in the at least one set allowing the set, when presented, to provide a perspective from each device represented in the set.

In another embodiment, entity builder 216 is configured to use presentation parameters templates where each presentation parameters template is usable for generating a different type of MPE supporting different formats, different media types for inclusion, and/or different ordering or arrangement schemes for the included media objects. In exemplary system 200, MPE database 210 is used for storing presentation parameters templates retrievable by the entity builder 216.

In FIG. 3, system 300 includes means for automatically creating an MPE using the presentation parameters and media objects with source device information associated with the media session, where the MPE includes a plurality of sets of media objects. At least one of the sets of media objects includes media objects received from different devices, according to block 106. In FIG. 4, database 400 includes means for automatically creating an MPE using the presentation parameters and media objects associated with a media session, where the MPE includes a plurality of sets of media objects. At least one of the sets of media objects includes media objects received from different devices, according to block 106. For example, tables 402, 410, 424, and 416 may be utilized to automatically create an MPE using presentation parameters and media objects associated with a media session. For example, MPE engine 212 may retrieve a row in MPE presentation parameters table 424 identified by an input and/or a message for automatically creating the identified MPE.

In the case of a coordinated MPE application 204, MPE engine is configured to detect when the data received associated with an MPE is complete. In response to detecting that data reception for the MPE is complete, MPE engine 212 may use the MPE ID of the MPE to retrieve a row from an MPE presentation parameters table in MPE database 210.

In the example media session and associated MPE discussed previously, invitation messages were sent to devices 310-314 and add messages identifying source devices were received from at least a portion of the invited devices including media objects, and the presentation parameters were received via a user interface presented as directed by SUI controller 318. MPE engine 212, in the particular embodiment, is a coordinated MPE engine 212 and configured to detect when data reception for a coordinated MPE and associated media session is complete. In one example, a media session is bounded by time. When an end time is reached or a time duration is complete, MPE engine 212 automatically initiates creation of the associated MPE by retrieving the MPE information from MPE presentation parameters table 424 in an embodiment using the model of the depicted in E-R diagram 400. In another example, supported by the embodiment, each device 310-314 is configured to send a message including a media session end indicator for indicating to MPE application 204 that the sending media capture device 310-314 has completed sending media objects. Those skilled in the art can envision and use other media session end conditions that MPE application 204 can be configured to detect and automatically initiate creation of an associated MPE.

As previously indicated, in system 300, MPE engine 212 uses the MPE type ID in the presentation parameters retrieved from MPE database 210 to identify an entity builder 328-332 configured to use the identified presentation parameters template in generating an MPE. In the example as stated, the MPE format to be generated includes a split screen with a video media object from a media session displayed in a first portion of a presentation space, and still images from the media session displayed in a second media session in a manner based on presentation settings for the particular MPE. In the example, the still images are to be displayed, for example, synchronously with the video media object based on offsets from a start time of still image capture and a start time of capture of a video media object. MPE engine 212 locates a compatible entity builder 328-332 and provides presentation parameters from MPE database 210 to the compatible entity builder 328-332. MPE engine 212 provides the presentation parameters of the MPE from MPE database 210 from, for example, MPE presentation parameters table 424, to the compatible entity builder 328-332, for example entity builder 2 330 along with a presentation parameters template identified in the presentation parameters and also retrieved by the MPE engine 212 from the MPE database 210 from, for example, the MPE presentation parameters template table 416.

Entity builder 330, using format information in the presentation parameters template, determines the format to be generated. In the example, the format information includes and/or references an HTML template with elements specified for generating a presentable representation with a portion for displaying still images and a portion for displaying a video stream. The HTML template includes tags for image display and script instructions for dynamically updating portions of the pages such as a still image portion based on the settings included in the presentation parameters. A script technology, such as asynchronous JAVASCRIPT™ and XML (or AJAX), may be used in an exemplary HTML template to enable the updating of still image media objects in accordance with the time synchronization specified in the settings.

As discussed previously, settings stored in settings column 432 can include any parameter affecting, for example, a font, a color, and/or a line style. Entity builder 330 then applies any appropriate settings to the HTML template. It is appreciated that this may be accomplished, for example, by updating an associated CSS specification included in the HTML template and/or stored in a reference CSS file template.

In exemplary entity builder 330, after settings included in the presentation parameters have been used in updating associated HTML and CSS templates using tags, scripts, and/or content, entity builder 330 uses the media session ID included in session ID column 428, in an embodiment, of the MPE presentation parameters record to request a plurality of media objects and source device information associated with the identified media session from MPE engine 212. MPE engine 212 provides the media session ID to session-set query engine 214, which retrieves media object information from media database 210. For example, session-set query engine 214 may retrieve rows in media object table 402 that include media object IDs 404 corresponding to media object IDs 414 located in rows of media session table 410 with a matching session ID in column 412. Session-set query engine 214 returns media object information retrieved from MPE database 210 for each media object associated with the identified media session to MPE engine 212. MPE engine 212 provides media object information to entity builder 330, but not the media object itself, in an embodiment. In other embodiments, media objects are also retrieved and provided to entity builder 330. However, in the current example, entity builder 330 uses the media object ID in the media object data for each media object in order to locate and retrieve the media object and, optionally, any associated resources stored with the media object.

In the example, entity builder 330 constructs a directory structure for storing each of the media objects and uses relative URI paths in the HTML and optional CSS template files that match the location in the directory structure where each media object is copied. Alternately, entity builder 330 generates a resource file with a URI for each media object. The resource file is accessible to the script instructions in the HTML page generated from the HTML template. The script instructions in and/or referenced by the HTML page are configured to use the resource file included in the HTML page and/or retrievable from the HTML page via a URI included in the page. Using the URIs included in a resource file, a script in the generated HTML page is capable of retrieving each of the media objects from a server. The server can be MPE application 204 or can be a separate server with access to MPE database 210 or to a database with copies of the media objects associated with the identified media session.

In one embodiment, entity builder 330 packages a generated HTML page and associated resources including the media objects according to the embodiment into a .zip file, for example. In another example, entity builder 330 may create a package comprising an executable installer optionally including a client for presenting the MPE where the invocation of a client and the presentation of the MPE may be automatically performed.

In the example described above, the package is compatible with a web server installation. For example, a web server-compatible package may include a JAVA™ archive (JAR) file for installation on a web server with a JAVA 2 platform, Enterprise Edition (J2EE) container. In an embodiment configured to receive viewer information including a message address for addressing invitation messages, entity builder 330 may generate messages including a link to the MPE. In yet another exemplary output, entity builder 330 may generate a dynamic HTML MPE and use a browser to render the MPE to a display buffer. A series of snapshots of the display buffer may be used by a video generating component of entity builder 330 to create a video stream. The MPE, in the form of the video stream, may therefore be included in a message sent to a viewer by either including a link to the MPE or by embedding the MPE within the message.

It is appreciated that systems 200 and 300 may be configured to support multiple presentation parameters templates and associated entity builders 216 and 328-332. The generation of HTML and video stream MPEs is described previously. Those skilled in the art will see, given the previous description, that various other output formats can be supported. For example, any tag language based format such as an XML format, a slideshow format, a PDF format, and an ADOBE™ FLASH format can be supported by a compatible entity builder. An entity builder can be template based, as described, or can be configured to generate MPEs without the use of templates.

The example MPE combines a video from a device and still images from one or more other devices. The still images are associated with one or more frames in the video media object to form a set in the MPE. Thus, the MPE includes a plurality of sets of media objects. At least one set includes a media object from different devices.

Various other formats can be supported as one skilled in the art can see given the previous description. For example, an MPE that includes a plurality of sets, where sets in the MPE include still images from different devices can be supported. For example, a group of people located in a variety of locations during the same time can use this format to create sets of media that are synchronized by time so that each set includes images captured at different locations by different still image media capture devices. Alternatively, the sets can be organized by subject metadata associated with the captured images. In this case, different perspectives of the same event can be captured by providing multiple media capture devices in the same location and at the same time.

It is appreciated that similar MPEs may be generated using any other media type or combination of media types, such as a plurality of video media objects captured by different video media capture devices, or mixed media types. One example of a mixed media type MPE includes an audio stream incorporated into a split screen display where still images are displayed in a first window and a video is displayed in a second window that is ordered or synchronized based on parameter information. The audio stream may be presented along with the split display and synchronized by time, subject, or other metadata. It is further appreciated that while the example MPEs described above are active, an MPE may also be static. For example, an MPE may include a static document or printed material, such as a photo album.

In addition to a split screen or other shared screen presentation, MPEs may interleave presentation of media objects of a media session. For example, a plurality of video streams can be received and used in creating a single video stream including interleaved portions of the received video streams. Interleaving is based on an MPE presentation parameters template type and associated settings. For example, the MPE presentation parameters template type and/or settings may specify the length of each video segment for each interleave portion. Time may be used to order the interleaving, or other characteristics of the media objects and/or their metadata may be used. A set can include at least two media objects where the presentation of at least one of the media objects is interleaved with the presentation of at least another media object. For example, a set can include a portion of a video from a first video media capture device, followed by a portion from a second video media capture device, and so on for additional media objects received from other video media capture devices. Interleaved still image and audio MPEs can be created in an analogous fashion as well as interleaved mixed media MPEs. Interleaving and shared display formats can be combined to generate another class of MPEs using the two formats together in various ways.

In another example, images received from a plurality of devices are used to generate sets for an MPE by creating a set of images using a technique previously described or any other technique. For example, for each set a master image is determined and indicated. When a set of the MPE is presented the master image of the set is presented. As a user points to portions of the master image another image from the set is displayed associated with the portion of the master image based on a characteristic of the master image and the image associated with the portion.

In addition to generating a set using the source of a media object, time, and/or subject information, those skilled the art can envision that set generation and ordering can be based on almost any characteristic of media objects in a media session including characteristics of the media capture device and the characteristics of the user of a media capture device or a submitter of a captured media object. Example characteristics include device name, media type, a media quality measure, media size, media duration, event information, location information, brightness, and or contrast. The list is not meant to be exhaustive. Measures or characteristics used can include absolute and/or relative measures as previously discussed, for example, with respect to the use of time for set creation and presentation order.

It is also appreciated that the ordering of sets in an MPE may be based on different settings from those included in presentation parameters table 424 or presentation parameters template table 416. For example, a characteristic of a media object may be used to determine one or more characteristics to be used to order a particular set. The result is a plurality of sets, wherein a first set is ordered and/or presented based on one characteristic and/or scheme and a second set is ordered and/or presented based on a different characteristic and/or scheme. For example, a user may order sets of images of his son and daughter taken at various locations by location primarily, but within each location the images may be ordered with images of his daughter first, followed by images of his son.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

1. A method for automatically creating a media presentation entity using media objects from a plurality of devices, the method comprising:
receiving a plurality of media objects from a plurality of devices;
identifying media objects associated with a media session from the received media objects;
receiving presentation parameters for creating a media presentation entity (MPE) from the media objects associated with the media session; and
automatically creating, using the presentation parameters, the MPE based on the media objects associated with the media session, the MPE including a plurality of sets of media objects, wherein at least one of the sets includes media objects received from different devices.

2. The method of claim 1 wherein the plurality of media objects includes at least one of a video media object, an audio media object, a still image media object, and a multimedia media object.

3. The method of claim 1 wherein the plurality of devices includes at least one of still-image media capture device, a video media capture device, and an audio media capture device.

4. The method of claim 1 further comprising identifying the media session including receiving at least one of a media object that includes media session information associated with the media session, media session information associated with the media session located in a file different from the received media objects and associated with a media object, and a media object manually associated with a media session.

5. The method of claim 4 wherein identifying the media session includes receiving media session information associated with the media session before, during or after receiving the plurality of media objects.

6. The method of claim 1 wherein receiving presentation parameters includes receiving a template indicator for identifying a template including at least one of format information, default presentation settings, types of media objects to be included in the media session, and a proportion of types of media objects to be included in the media session.

7. The method of claim 6 wherein receiving a template selection includes receiving at least one of format information, a media object, a presentation size, an ordering of the media objects, a default border color, a default background color, a border width, font parameters, grouping parameters, and annotation parameters.

8. The method of claim 1 wherein automatically creating an MPE includes creating at least two sets of media objects that are synchronized based on a characteristic of the media objects included in the sets.

9. The method of claim 8 wherein the at least two sets of media objects are synchronized based on at least one of a common time period, a common location, a common media type, a common subject matter, and metadata determinable by media analysis.

10. The method of claim 1 wherein automatically creating an MPE includes at least one of creating an MPE for simultaneously presenting a portion of the plurality of sets of media objects and creating an MPE for sequentially presenting a portion of the plurality of sets of media objects.

11. The method of claim 1 wherein automatically creating an MPE includes creating the MPE based on at least one of a start time of each media object and a time offset of each media object.

12. The method of claim 1 comprising:
receiving a request to create the MPE from at least one of the plurality of devices; and
sending an invitation associated with the MPE.

13. The method of claim 12 wherein receiving a request to create the media session includes receiving media session information associated with the media session and device information identifying a subset of the plurality of devices.

14. A system for automatically creating a media presentation entity using media objects from a plurality of devices, the system comprising:
a content handler for receiving a plurality of media objects from a plurality of devices;
a media presentation entity (MPE) engine for identifying media objects associated with a media session from the received media objects and for receiving presentation parameters for creating an MPE from the media objects associated with the media session; and
an entity builder for automatically creating, using the presentation parameters, the MPE based on the media objects associated with the media session, the MPE including a plurality of sets of media objects, wherein at least one of the sets includes media objects from different devices.

15. The system of claim 14 wherein the content handler is configured to receive at least one of a video media object, an audio media object, a still image media object, and a multimedia media object.

16. The system of claim 14 wherein the content handler is configured to receive media objects from at least one of a still-image media capture device, a video media capture device, and an audio media capture device.

17. The system of claim 14 wherein the MPE engine is configured to receive at least one of a media object that includes media session information, media session information located in a file different from the received media objects and associated with the media objects, media objects manually associated with media session information, and media session information associated with the media session.

18. The system of claim 14 wherein the MPE engine is configured to receive media session information before, during or after receiving the plurality of media objects.

19. The system of claim 14 wherein the MPE engine is configured to receive a template indicator for identifying a template including at least one of format information, default presentation settings, types of media objects to be included in the media session, and a proportion of types of media objects to be included in the media session.

20. The system of claim 19 wherein the MPE engine is configured to receive parameters for populating a template, where the template includes at least one of format information, a media object, a presentation size, an ordering of the media objects, a default border color, a default background color, a border width, font parameters, grouping parameters, and annotation parameters.

21. The system of claim 14 wherein the entity builder is configured to create at least two sets of media objects that are synchronized based on a characteristic of the media objects included in the sets.

22. The system of claim 21 wherein the at least two sets of media objects are synchronized based on at least one of a common time period, a common location, a common media type, a common subject matter, and metadata determinable by media analysis.

23. The system of claim 14 wherein the entity builder is configured to create at least one of an MPE for simultaneously presenting a portion of the plurality of sets of media objects and an MPE for sequentially presenting the plurality of sets of media objects.

24. The system of claim 14 wherein the entity builder is configured to create the MPE based on at least one of a start time of each media object and a time offset of each media object.

25. The system of claim 14 wherein:
the content handler is configured to receive input for creating a media session with a subset of the plurality of media capture devices;
the content handler is configured to send an invitation message to the subset of the plurality of media capture devices; and
the entity builder is configured to automatically create the MPE using at least one media object received from the at least a subset of the plurality of media capture devices.

26. The system of claim 14 wherein:
the content handler is configured to receive a request to create the MPE associated with a media session;
the content handler is configured to send an invitation message associated with the MPE;
the content handler is configured to receive an add message including at least one media object associated with the media session from at least one of the devices; and
the entity builder is configured to automatically create the MPE including the at least one media object received from the at least one device.

27. A system for automatically creating a media presentation entity using media objects from a plurality of devices, the system comprising:
means for receiving a plurality of media objects from a plurality of devices;
means for identifying media objects associated with a media session from the received media objects;
means for receiving presentation parameters for creating a media presentation entity (MPE) from the media objects associated with the media session; and
means for automatically creating, using the presentation parameters, the MPE based on the media objects associated with the media session, the MPE including a plurality of sets of media objects, wherein at least one of the sets includes media objects received from different devices.

28. A computer program product comprising computer executable instructions embodied in a computer readable medium for performing steps comprising:
receiving a plurality of media objects from a plurality of devices;
identifying media objects associated with a media session from the received media objects;
receiving presentation parameters for creating a media presentation entity (MPE) from the media objects associated with the media session; and
automatically creating, using the presentation parameters, the MPE based on the media objects associated with the media session, the MPE including a plurality of sets of media objects, wherein at least one of the sets includes media objects received from different devices.
